(19) United States
(12) Patent Application Publication
(10) Pub. No.: US 2024/0178449 A1
(43) Pub. Date: May 30, 2024

(54) Liquid Electrolyte For An Electrochemical Cell With A Silicon-Based Anode

(71) Applicant: APPLE INC., Cupertino, CA (US)

(72) Inventors: Alan A. Ritchie, Menlo Park, CA (US); Karl M. Brown, Los Gatos, CA (US); Andrew Basile, Santa Clara, CA (US); Bernd Jurgen Neudecker, Los Gatos, CA (US)

(21) Appl. No.: 18/434,918

(22) Filed: Feb. 7, 2024

Related U.S. Application Data
(63) Continuation-in-part of application No. 16/922,332, filed on Jul. 7, 2020, now Pat. No. 11,908,998.
(60) Provisional application No. 62/901,982, filed on Sep. 18, 2019.

(51) Int. Cl. H01M 10/0567; H01M 10/052; H01M 10/0525; H01M 10/0568; H01M 10/0569

(52) U.S. Cl. CPC H01M 10/0567; H01M 10/052; H01M 10/0525; H01M 10/0568; H01M 10/0569; H01M 2300/0028

(57) ABSTRACT

Liquid electrolytes for electrochemical cells with silicon-based anodes are composed of an aprotic solvent, an ionic liquid, a lithium salt, and 8 mol % to 30 mol % hydrofluoroether. A molar ratio of the hydrofluoroether to the lithium salt is 0.22:1 to 0.83:1. The liquid electrolytes achieve at least a 50% improvement in cycle life over conventional electrolytes, extend capacity retention and delay increases in internal resistance.

### CROSS-REFERENCE TO RELATED APPLICATION

This application is a continuation-in-part application of U.S. application Ser. No. 16/922,332 filed on Jul. 7, 2020, which claims priority to Provisional Application Ser. No. 62/901,982, filed on Sep. 18, 2019, the entireties of which are hereby incorporated by reference.

### TECHNICAL FIELD

This application generally relates to a liquid-based electrolyte for batteries using a silicon-based anode, the electrolyte comprising both ionic liquid and a hydrofluoroether, resulting in improved cell performance.

### BACKGROUND

Lithium metal batteries have received significant attention as advanced high-performance next generation batteries. However, these high voltage rechargeable batteries can face performance obstacles due at least in part to high reactivity between the battery components and traditional electrolytes. For example, the thermodynamic instability of lithium metal can cause irreversible and continuous reactions between lithium metal and the electrolyte that generate thick solid electrolyte interphase (SEI) layers on the lithium metal surface, consume lithium and electrolyte, and increase the internal resistance, thus shortening cycle life. Large volumetric changes can occur in the lithium metal anode during repeated cycling, but the aforementioned SEI films can be too frail to fully suppress such significant changes in the lithium metal electrode. The resulting structural instability limits the applications of these batteries.

The use of lithium-ion batteries using silicon-based anode material has grown. Silicon is used as anode material in lithium-ion batteries because silicon has a high theoretical capacity, providing batteries with improved energy density. Although the energy density of lithium-ion batteries has increased with the use of silicon-based anode material, the silicon-based material has limited cycle life due to the large volume changes that silicon-based materials undergo during battery cycling. These large volume changes, as large as 300%-400%, can result in fracture of silicon particles, isolated fragments of particles that no longer contribute to capacity, and a weak solid-electrolyte interphase (SEI) prone to cracking and delamination. This limited cycle life deters wider application of the technology.

### SUMMARY

The disclosed embodiments provide a liquid electrolyte formulated for use with both a lithium metal battery and a lithium-ion battery having a silicon-based anode. The liquid electrolytes disclosed herein show improved performance in both lithium metal batteries and lithium-ion batteries with silicon-based anodes over conventional liquid electrolytes. One embodiment of a liquid electrolyte comprises an aprotic solvent, an ionic liquid, a lithium salt, and 8 mol % to 30 mol % hydrofluoroether. A ratio of the hydrofluoroether to the lithium salt is 0.22:1 to 0.83:1.

In some embodiments, the ratio of the hydrofluoroether to the lithium salt is 0.22:1 to 0.7:1.

In some embodiments, a ratio of the hydrofluoroether to the aprotic solvent is 0.1:1 to 1:1.

In some embodiments, the ratio of the hydrofluoroether to solvent is 0.15:1 to 0.5:1, wherein the solvent is the aprotic solvent and the ionic liquid.

In some embodiments, a ratio of hydrofluoroether to the ionic liquid is 0.5:1 to 10:1.

The aprotic solvent can be a linear carbonate, a cyclic carbonate, or a linear ether selected from the group consisting of monoglyme, diglyme, triglyme, tetraglyme, a cyclic ether or a cyclic acetal.

In some embodiments, the aprotic solvent is dimethyl carbonate (DMC).

The hydrofluoroether can be 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2-trifluoroethyl ether (TFTFE), tris(hexafluoroisopropyl) phosphate, tris(2,2,2-triflouroethyl) borate, or any combination thereof.

In some embodiments, the hydrofluoroether is BTFE.

The ionic liquid can be N-propyl-N-methylpyrrolidinium bis(fluorosulfonyl)imide (PYR₁₃FSI), N-butyl-N-methylpyrrolidinium bis(fluorosulfonyl)imide (PYR₁₄FSI); N-propyl-N-methylpyrrolidinium bis(trifluoromethanesulfonyl)imide (PYR₁₃TFSI); or N-butyl-N-methylpyrrolidinium bis(trifluoromethanesulfonyl)imide (PYR₁₄TFSI), as well as other lithium compatible ionic liquids.

The lithium salt can be lithium bis(fluorosulfonyl)imide (LiFSI), lithium bis(trifluoromethanesulfonyl)imide (LiTFSI), and lithium bis(pentafluoroethanesulfonyl)imide (LiBETI).

In one embodiment, the aprotic solvent is DMC, the ionic liquid is PYR₁₃FSI, the lithium salt is LiFSI, and the hydrofluoroether is BTFE, the liquid electrolyte having the following composition: 29 mol % LiFSI+7 mol % PYR₁₃FSI+44 mol % DMC+20 mol % BTFE.

In another embodiment, the liquid electrolyte has the following composition: 31 mol % LiFSI+9 mol % PYR₁₃FSI+46 mol % DMC+14 mol % BTFE.

In another embodiment, the liquid electrolyte has the following composition: 29 mol % LiFSI+8 mol % PYR₁₃FSI+44 mol % DMC+19 mol % BTFE.

In another embodiment, the liquid electrolyte has the following composition: DMC; PYR₁₃FSI; a lithium salt; and 8 mol % to 30 mol % BTFE, wherein a molar ratio of BTFE to lithium salt is 0.22:1 to 0.83:1, a molar ratio of BTFE to DMC is 0.1:1 to 1:1, and a molar ratio of BTFE to a total of DMC and PYR₁₃FSI is 0.15:1 to 0.5:1.

Also disclosed is an electrochemical cell having a cathode, an anode and the liquid electrolytes disclosed herein.

### BRIEF DESCRIPTION OF THE DRAWINGS

FIG. 1A is a graph of the discharge capacity versus number of cycles comparing a cell using a liquid electrolyte without a hydrofluoroether and cells using liquid electrolytes with hydrofluoroether.

FIG. 1B is a graph of the direct current internal resistance (DCIR) versus number of cycles comparing the cell using the liquid electrolyte without a hydrofluoroether and the cells using the liquid electrolytes with hydrofluoroether.

FIG. 2 is a cross-section view of a lithium metal battery as disclosed herein.

FIG. 3A is a graph comparing capacity retention for an electrochemical cell with the liquid electrolyte disclosed herein against an electrochemical cell with a liquid electrolyte with no hydrofluoroether.

FIG. 3B is a graph comparing the specific capacity of the electrochemical cell with the liquid electrolyte disclosed herein against the electrochemical cell with the liquid electrolyte with no hydrofluoroether.

### DETAILED DESCRIPTION

Liquid electrolytes for lithium metal batteries should be chemically compatible with metallic lithium, allow for cell reversibility utilizing a suitable cathode material, be thermodynamically stable at high voltage, and be non-flammable. However, conventional liquid electrolytes fail to provide one or more of these requirements. In some cases, high reactivity between the battery components and traditional electrolytes results in structural instability and cathode/electrolyte interface degradation. Transition metal cathode materials, for example, can have catalytically active surfaces that promote the decomposition of conventional electrolytes, resulting in corrosive species that structurally degrade the cathode material.

Conventional organic solvent electrolytes, for example, are not thermodynamically stable at high voltages. Ether electrolytes may decompose at the cathode above 4V and carbonate electrolytes can be unstable with the lithium anode material at any voltage. Organic solvent electrolytes can also have low flash points. As an example, 1,2-dimethyoxyethane (DME) has a flash point of −2° C. and dimethyl carbonate (DMC) has a flash point of 17° C. The flash points of organic solvents improve when lithium salt is added, but still do not reach non-flammable ratings. As examples, DME with 10 mol % LiFSI has a flash point of less than 25° C. and DME with 40 mol % LiFSI has a flash point of less than 40° C.

Silicon-based materials are used as anode active material in lithium-ion batteries because silicon has a high theoretical capacity, providing batteries with improved energy density. Although the energy density of lithium-ion batteries has increased with the use of silicon-based anode material, the silicon-based material has limited cycle life due to the large volume changes that silicon experiences during battery cycling. These large volume changes, as large as 300%-400%, can result in, as one example, a weakened SEI prone to cracking and delamination when conventional electrolytes are used. The SEI is formed by the decomposition of organic and inorganic compounds during cycling, such organic and inorganic compounds components of the liquid electrolyte used in the lithium-ion batteries. Ethylene carbonate (EC)-based electrolytes are intrinsically less stable with silicon. The structure of the SEI generated from the EC solvent cannot accommodate the repetitive and extensive swelling of the silicon in the anode during cycling.

Disclosed herein are liquid electrolytes for electrochemical cells that are chemically compatible with the anode material, whether lithium metal or silicon-based, are non-flammable, are thermodynamically stable at voltages over 4V, suppress the instability of the cathode material and suppress the decomposition of the electrolyte. The liquid electrolytes disclosed herein achieve at least a 50% improvement in cycle life over known electrolytes, extend capacity retention and delay increases in internal resistance.

One embodiment of a liquid electrolyte for an electrochemical cell consists of an aprotic solvent, an ionic liquid compatible with lithium metal, a lithium salt, and 8 mol % to 30 mol % hydrofluoroether. In other embodiments, the liquid electrolyte may further consist of up to 5 mol % additives. A molar ratio of the hydrofluoroether to the lithium salt is 0.22:1 to 0.83:1, and more particularly, 0.22:1 to 0.7:1. All ranges disclosed herein are inclusive.

The molar ratio of the hydrofluoroether to the aprotic solvent can be 0.1:1 to 1:1, more particularly 0.15:1 to 0.8:1, and even more particularly 0.15:1 to 0.5:1. In some embodiments, the molar ratio of the hydrofluoroether to solvent can be 0.1:1 to 0.8:1, and more particularly 0.15:1 to 0.5:1. “Solvent” here refers to the total of both the aprotic solvent and the ionic liquid. In some embodiments, a molar ratio of hydrofluoroether to the ionic liquid is 0.5:1 to 10:1.

The lithium ion, its anion, the ionic liquid cation, and its anion are solvated to form a complex such that the aprotic solvent is bound in the mixture, resulting in high flash points even when aprotic solvents with low flash points are used. The ionic liquid is a salt, yet already molten. The ionic liquid and the aprotic solvent are very miscible with each other, resulting in their particular solvation interaction. The cell reversibility is significantly improved with these electrolytes due to the ability of the mixture to solvate unusually high salt content. The ionic liquid, which is typically non-flammable and chemically compatible with lithium metal and silicon, increases the flash point of the electrolyte while improving the cell stability. Although ionic liquids have limited transport properties, the large amount of lithium salt in the electrolyte negates these limited properties. As the lithium salt content increases, the viscosity of the ionic liquid increases and cell wetting decreases. The mixture of the ionic liquid and the aprotic solvent balances out the viscosity.

The addition of the hydrofluoroether, in part, improves the wettability of the liquid electrolyte as the lithium salt is not very soluble in the hydrofluoroether. It is believed that the relationship between the high molarity lithium salt component and the low molarity hydrofluoroether component, in combination with the stabilizing ionic liquid and the aprotic solvent, is the key to the improved performance metrics realized in test cells using the liquid electrolyte. The performance metrics fall off when the hydrofluoroether:lithium salt ratio falls outside of the 0.22:1 to 0.83:1 range, and more particularly, outside of the 0.22:1 to 0.7:1 range.

The hydrofluoroether can be, but is not limited to, 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2-trifluoroethyl ether (TFTFE), and any combination thereof. As used herein, the term hydrofluoroether also includes tris(hexafluoroisopropyl) phosphate, tris(2,2,2-triflouroethyl) borate and other like heteroatom-centered hydrofluoroether functionalized compounds.

The aprotic solvent can be one or more of a linear carbonate, a cyclic carbonate, or a linear ether selected from the group consisting of monoglyme, diglyme, triglyme and tetraglyme, a cyclic ether such as dioxane (DIOX) or a cyclic acetal such as dioxolane (DOL). As non-limiting examples, DME, ethyl methyl carbonate (EMC), DMC, and diethyl carbonate (DEC) are suitable aprotic organic solvents.

The ionic liquid should be compatible with the lithium anode. Examples include N-ethyl-N-methylpyrrolidinium bis(fluorosulfonyl)imide (PYR₁₂FSI), N-propyl-N-methylpyrrolidinium bis(fluorosulfonyl)imide (PYR₁₃FSI), N-butyl-N-methylpyrrolidinium bis(fluorosulfonyl)imide (PYR₁₄FSI); N-propyl-N-methylpyrrolidinium bis(trifluoromethanesulfonyl)imide (PYR₁₃TFSI); or N-butyl-N-methylpyrrolidinium bis(trifluoromethanesulfonyl)imide (PYR₁₄TFSI). Other ionic liquids compatible with lithium can also be used, such as, but not limited to, tetrafluoroborate (BF₄), hexafluorophosphate (PF₆), triflate (OTf) and bis(pentafluoroethanesulfonyl)imide (BETI) and phosphonium or ammonium cations. Ionic liquids such as imidazolium are not compatible with the lithium anode.

The lithium salt should not be sensitive to moisture so that it does not break down. The lithium salt should have weakly coordinating anions and be hydrolytically stable. Non-limiting examples of the lithium salt is lithium bis(fluorosulfonyl)imide (LiFSI), lithium bis(trifluoromethanesulfonyl)imide (LiTFSI), and lithium bis(pentafluoroethanesulfonyl)imide (LiBETI). One or a combination of lithium salts can be used.

The additives, if used, are those known to the skilled artisan that may be used to improve electrolyte performance by improving, for example, the electrolyte conductivity or thermal stability. Non-limiting examples include vinylene carbonate, vinyl ethylene carbonate and lithium salts such as LiF and LiNO₃.

In some embodiments, the aprotic solvent is DMC, the ionic liquid is PYR₁₃FSI, the lithium salt is LiFSI, and the hydrofluoroether is BTFE, the liquid electrolytes having the following compositions:

30 mol % LiFSI+8 mol % PYR₁₃FSI+45 mol % DMC+17 mol % BTFE;

31 mol % LiFSI+9 mol % PYR₁₃FSI+46 mol % DMC+14 mol % BTFE;

29 mol % LiFSI+8 mol % PYR₁₃FSI+44 mol % DMC+19 mol % BTFE; and

29 mol % LiFSI+7 mol % PYR₁₃FSI+44 mol % DMC+20 mol % BTFE.

Some embodiments have BTFE between 13 mol % and 21 mol %, inclusive, with the other elements adjusting to accommodate while maintaining the molar ratios of hydrofluoroether to lithium salt of 0.22:1 to 0.83:1; hydrofluoroether to aprotic solvent of 0.1:1 to 1:1; and hydrofluoroether to solvent of 0.15:1 to 0.5:1.

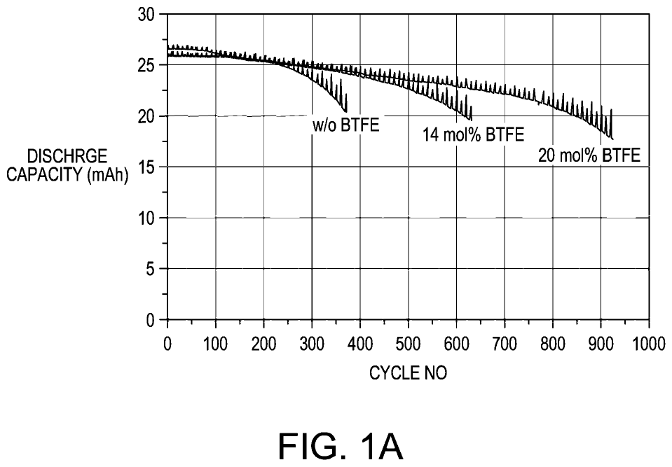

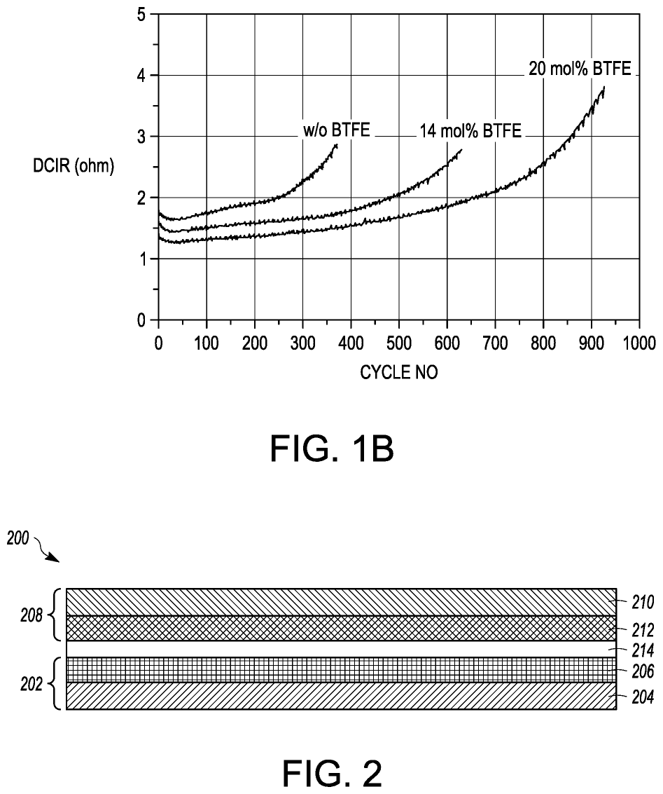

The liquid electrolytes disclosed herein can improve the cycle life of a battery cell by 50% or more, can extend capacity retention and can delay DCIR increase. FIGS. 1A and 1B are graphs illustrating the improved cell performance. FIGS. 1A and 1B compare performance of a cell using a liquid electrolyte without a hydrofluoroether to cells using liquid electrolytes as disclosed herein. In particular, the two liquid electrolytes used to achieve the cell performance shown in FIGS. 1A and 1B have the following compositions. The electrolyte with 14 mol % BTFE has the following composition:

31 mol % LiFSI+9 mol % PYR₁₃FSI+46 mol % DMC+14 mol % BTFE.

The molar ratio of hydrofluoroether to lithium salt is 0.45:1. The ratio of hydrofluoroether to aprotic solvent is 0.30. The ratio of hydrofluoroether to total solvent is 0.25. The ratio of hydrofluoroether to ionic liquid is 1.56. The electrolyte with 20 mol % BTFE has the following composition:

29 mol % LiFSI+7 mol % PYR₁₃FSI+44 mol % DMC+20 mol % BTFE.

The molar ratio of hydrofluoroether to lithium salt is 0.69:1. The ratio of hydrofluoroether to aprotic solvent is 0.46:1. The ratio of hydrofluoroether to total solvent is 0.39. The ratio of hydrofluoroether to ionic liquid is 2.86. The 12 cm² cell used a 10 μm lithium metal anode, 14 μm ceramic coated polyethylene and 39 μm LiCoO₂ cathode. The cycle test was performed at 4.25-3.0V; C/5 discharge in cycles 1, 10, 30, 50, 70, etc.; C/10 discharge in cycles 20, 40, 60, 80, etc.; C/2 discharge in all other cycles; and C/7 charge for all cycles.

FIG. 1A graphs discharge capacity against number of cycles. The cell using the liquid electrolyte without the hydrofluoroether only achieved about 360 cycles with 80% capacity retention or higher while the cell using the liquid electrolyte with 14% hydrofluoroether as disclosed herein achieved about 630 cycles with 80% capacity retention or higher and the cell using the liquid electrolyte with 20% hydrofluoroether as disclosed herein achieved about 900 cycles with 80% capacity retention or higher.

FIG. 1B graphs DCIR against number of cycles. The cell using the liquid electrolyte without the hydrofluoroether saw a DCIR increase (above 2.5 ohms) at about 340 cycles while the cell using the liquid electrolyte with 14% hydrofluoroether as disclosed herein did not see the DCIR increase to over 2.5 ohms until about 600 cycles and the cell using the liquid electrolyte with 20% hydrofluoroether as disclosed herein did not see the DCIR increase to over 2.5 ohms until about 800 cycles.

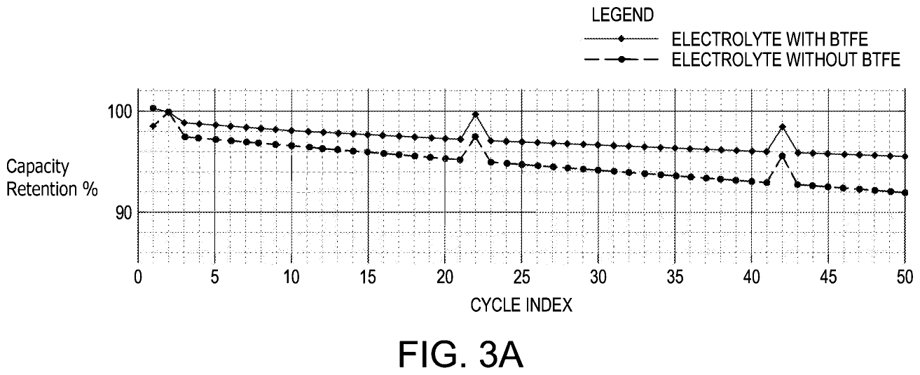

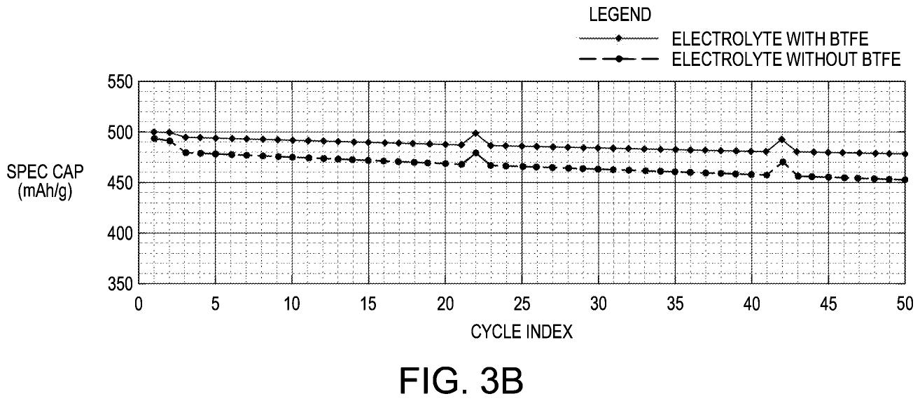

FIGS. 3A and 3B compare performance of a cell using a liquid electrolyte without a hydrofluoroether to a cell using a liquid electrolyte as disclosed herein. In particular, the liquid electrolytes used to achieve the cell performance shown in FIGS. 3A and 3B have the following composition:

29 mol % LiFSI+8 mol % PYR₁₃FSI+44 mol % DMC+19 mol % BTFE.

The cell used a 63 μm silicon-based anode, 14 μm ceramic coated polyethylene separator and 58 μm LiCoO₂ cathode. The cycle test was performed at 4.40-3.0V at 45° C.; C/2 discharge and C/2 charge in cycles, C/5 discharge and C/5 charge in cycles 22 and 42.

FIG. 3A compares capacity retention for an electrochemical cell with the liquid electrolyte disclosed above against an electrochemical cell with a liquid electrolyte with no hydrofluoroether. FIG. 3B compares the specific capacity of the electrochemical cell with the liquid electrolyte disclosed above against the electrochemical cell with the liquid electrolyte with no hydrofluoroether.

An aspect of the disclosed embodiments is an electrochemical cell 200, the layers of which are shown in cross-section in FIG. 2. The electrochemical cell 200 has an anode 202 with an anode current collector 204 and an anode active material 206 disposed on the anode current collector 204. The electrochemical cell 200 also has a cathode 208 with a cathode current collector 210 and a cathode active material 212 disposed over the cathode current collector 210. The cathode 208 and the anode 202 are separated by a separator 214 and the liquid electrolyte disclosed herein.

The cathode current collector 210 can be, for example, an aluminum sheet or foil. Cathode active materials 212 can include one or more lithium transition metal oxides which can be bonded together using binders and optionally conductive fillers such as carbon black. Lithium transition metal oxides can include, but are not limited to, LiCoO₂, LiNiO₂, LiNi_{0.8}Co_{0.15}Al_{0.05}O₂, LiMnO₂, Li(Ni_{0.5}Mn_{0.5})O₂, LiNiₓCo_{y}Mn_{z}O₂, Spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. As needed, the cathode active material 212 can contain an electroconductive material, a binder, etc.

The anode active material 206 can comprise at least one selected from the group consisting of a metal material, an alloy material and a carbonaceous material. The anode active material 206 is not particularly limited, and can comprise lithium metals, lithium alloys, lithium-containing metal oxides, lithium-containing metal sulfides, lithium-containing metal nitrides, carbonaceous materials such as graphite, etc. The anode active material 206 may alternatively be a silicon-based anode active material. The silicon-based anode active material is not limited except to include some form of silicon or silicon alloy with a volumetric capacity of greater than or equal to 500 mAh/cc. Non-limiting examples of silicon-based anode active material include Si, SiOx, and Si/SiOx composites. A conducting agent may be used. Further, one or more of a binder and a solvent may be used to prepare a slurry that is applied to the current collector, for example. The anode current collector 204 can be a copper or nickel sheet or foil, as a non-limiting example.

The separator 214 may be a single layer or multi-layer of polyethylene, polypropylene, and polyvinylidene fluoride, as non-limiting examples.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art.

What is claimed is:

1. A liquid electrolyte for an electrochemical cell, having a composition as follows:
an aprotic solvent;
an ionic liquid;
a lithium salt; and
8 mol % to 30 mol % hydrofluoroether, wherein a molar ratio of the hydrofluoroether to the lithium salt is 0.22:1 to 0.83:1.

2. The liquid electrolyte of claim 1, wherein the molar ratio of the hydrofluoroether to the lithium salt is 0.22:1 to 0.7:1.

3. The liquid electrolyte of claim 1, wherein a molar ratio of the hydrofluoroether to the aprotic solvent is 0.1:1 to 1:1.

4. The liquid electrolyte of claim 1, wherein the molar ratio of the hydrofluoroether to solvent is 0.15:1 to 0.5:1, wherein the solvent is the aprotic solvent and the ionic liquid.

5. The liquid electrolyte of claim 1, wherein a molar ratio of hydrofluoroether to the ionic liquid is 10:1 to 0.5:1.

6. The liquid electrolyte of claim 1, wherein the aprotic solvent is a linear carbonate, a cyclic carbonate, a linear ether selected from the group consisting of monoglyme, diglyme, triglyme and tetraglyme, a cyclic ether or a cyclic acetal.

7. The liquid electrolyte of claim 1, wherein the aprotic solvent is dimethyl carbonate (DMC).

8. The liquid electrolyte of claim 1, wherein the hydrofluoroether is 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2-trifluoroethyl ether (TFTFE), or any combination thereof.

9. The liquid electrolyte of claim 1, wherein the hydrofluoroether is BTFE.

10. The liquid electrolyte of claim 1, wherein the ionic liquid is N-propyl-N-methylpyrrolidinium bis(fluorosulfonyl)imide (PYR₁₃FSI), N-butyl-N-methylpyrrolidinium bis(fluorosulfonyl)imide (PYR₁₄FSI); N-propyl-N-methylpyrrolidinium bis(trifluoromethanesulfonyl)imide (PYR₁₃TFSI); or N-butyl-N-methylpyrrolidinium bis(trifluoromethanesulfonyl)imide (PYR₁₄TFSI).

11. The liquid electrolyte of claim 1, wherein the lithium salt is lithium bis(fluorosulfonyl)imide (LiFSI), lithium bis(trifluoromethanesulfonyl)imide (LiTFSI), and lithium bis(pentafluoroethanesulfonyl)imide (LiBETI).

12. The liquid electrolyte of claim 1, wherein the aprotic solvent is DMC, the ionic liquid is PYR₁₃FSI, the lithium salt is LiFSI, and the hydrofluoroether is BTFE, the liquid electrolyte having the following composition:
29 mol % LiFSI+7 mol % PYR₁₃FSI+44 mol % DMC+20 mol % BTFE.

13. The liquid electrolyte of claim 1, wherein the aprotic solvent is DMC, the ionic liquid is PYR₁₃FSI, the lithium salt is LiFSI, and the hydrofluoroether is BTFE, the liquid electrolyte having the following composition:
31 mol % LiFSI+9 mol % PYR₁₃FSI+46 mol % DMC+14 mol % BTFE.

14. The liquid electrolyte of claim 1, wherein the aprotic solvent is DMC, the ionic liquid is PYR₁₃FSI, the lithium salt is LiFSI, and the hydrofluoroether is BTFE, the liquid electrolyte having the following composition:
29 mol % LiFSI+8 mol % PYR₁₃FSI+44 mol % DMC+19 mol % BTFE.

15. A battery, comprising:
the liquid electrolyte of claim 1;
a cathode having a cathode current collector and a cathode active material comprising a lithium transition metal oxide; and
an anode having an anode current collector and an anode active material comprising silicon.

16. A liquid electrolyte for an electrochemical cell, having a composition as follows:
DMC;
PYR₁₃FSI;
a lithium salt; and
8 mol % to 30 mol % BTFE,
wherein a molar ratio of BTFE to lithium salt is 0.22:1 to 0.83:1, a molar ratio of BTFE to DMC is 0.1:1 to 1:1, and a molar ratio of BTFE to a total of DMC and PYR₁₃FSI is 0.15:1 to 0.5:1.

17. The liquid electrolyte of claim 16, wherein the lithium salt is LiFSI.

18. The liquid electrolyte of claim 16, wherein the molar ratio of the BTFE to the lithium salt is 0.22:1 to 0.7:1.

19. The liquid electrolyte of claim 16, having 13 mol %-21 mol % BTFE.

20. The liquid electrolyte of claim 16, wherein the lithium salt is LiFSI and the electrolyte has the following composition:
29 mol % LiFSI+8 mol % PYR₁₃FSI+44 mol % DMC+19 mol % BTFE.
